(19) United States
(12) Patent Application Publication
(10) Pub. No.: US 2019/0230096 A1
(43) Pub. Date: Jul. 25, 2019

(54) Monolithic Three-Dimensional Pattern Processor Supporting Massive Parallelism

(71) Applicant: Guobiao ZHANG, Corvallis, OR (US)

(72) Inventor: Guobiao ZHANG, Corvallis, OR (US)

(73) Assignee: HangZhou HaiCun Information Technology Co., Ltd., HangZhou (CN)

(21) Appl. No.: 16/371,075

(22) Filed: Mar. 31, 2019

Related U.S. Application Data
(63) Continuation of application No. 16/248,914, filed on Jan. 16, 2019.
Application No. 16/248,914 is a continuation-in-part of application No. 15/973,526, filed on May 7, 2018.
Application No. 15/973,526 is a continuation-in-part of application No. 15/452,728, filed on Mar. 7, 2017.

(30) Foreign Application Priority Data
Mar. 7, 2016 (CN) 201610127981.5
Mar. 3, 2017 (CN) 201710122861.0
Mar. 7, 2017 (CN) 201710130887.X
Apr. 26, 2018 (CN) 201810381860.2
Apr. 27, 2018 (CN) 201810388096.1
Jan. 13, 2019 (CN) 201910029515.7

(51) Int. Cl. H04L 29/06; G06F 21/56; G06F 16/903; G10L 15/34

(52) U.S. Cl. CPC H04L 63/145; G06F 21/562; G06F 2221/032; G10L 15/34; H04L 63/1416; G06F 16/90344

(57) ABSTRACT

A monolithic three-dimensional (3-D) pattern processor supporting massive parallelism comprises a plurality of storage-processing units (SPU's). Each of the SPU's comprises at least a 3-D memory (3D-M) array and a pattern-processing circuit. Being monolithic, the 3D-M arrays and the pattern-processing circuits of the preferred pattern processor are formed on a single die and communicatively coupled by a plurality of intra-die connections. To ensure parallelism, each of the SPU's comprises no more than eight 3D-M arrays.

### CROSS-REFERENCE TO RELATED APPLICATIONS

This application is a continuation of application “Monolithic Three-Dimensional Pattern Processor”, application Ser. No. 16/248,914, filed Jan. 16, 2019, which is a continuation-in-part of application “Distributed Pattern Storage-Processing Circuit Comprising Three-Dimensional Vertical Memory Arrays”, application Ser. No. 15/973,526, filed Mar. 7, 2018, which is a continuation-in-part of application “Distributed Pattern Processor Comprising Three-Dimensional Memory”, application Ser. No. 15/452,728, filed Mar. 7, 2017.

These applications claim priorities from Chinese Patent Application No. 201610127981.5, filed Mar. 7, 2016; Chinese Patent Application No. 201710122861.0, filed Mar. 3, 2017; Chinese Patent Application No. 20171 01 30887.X, filed Mar. 7, 2017; Chinese Patent Application No. 201810381860.2, filed Apr. 26, 2018; Chinese Patent Application No. 201810388096.1, filed Apr. 27, 2018; Chinese Patent Application No. 201910029515.7, filed Jan. 13, 2019, in the State Intellectual Property Office of the People's Republic of China (CN), the disclosures of which are incorporated herein by references in their entireties.

### BACKGROUND

### 1. Technical Field of the Invention

The present invention relates to the field of integrated circuit, and more particularly to a pattern processor.

### 2. Prior Art

Pattern processing includes pattern matching and pattern recognition, which are the acts of searching a target pattern (i.e. the pattern to be searched) for the presence of the constituents or variants of a search pattern (i.e. the pattern used for searching). The match usually has to be “exact” for pattern matching, whereas it could be “likely to a certain degree” for pattern recognition. As used hereinafter, search patterns and target patterns are collectively referred to as patterns; pattern database refers to a database containing related patterns. Pattern database includes search-pattern database (also known as search-pattern library) and target-pattern database.

Pattern processing has broad applications. Typical pattern processing includes code matching, string matching, speech recognition and image recognition. Code matching is widely used in information security. Its operations include searching a virus in a network packet or a computer file; or, checking if a network packet or a computer file conforms to a set of rules. String matching, also known as keyword search, is widely used in big-data analytics. Its operations include regular-expression matching. Speech recognition identifies from the audio data the nearest acoustic/language model in an acoustic/language model library. Image recognition identifies from the image data the nearest image model in an image model library.

The pattern database has become large: the search-pattern library (including related search patterns, e.g. a virus library, a keyword library, an acoustic/language model library, an image model library) is already big; while the target-pattern database (including related target patterns, e.g. computer files on a whole disk drive, a big-data database, an audio archive, an image archive) is even bigger. The conventional processor and its associated von Neumann architecture have great difficulties to perform fast pattern processing on large pattern databases.

### Objects and Advantages

It is a principle object of the present invention to improve the speed (e.g. throughput) and efficiency of pattern processing on large pattern databases.

It is a further object of the present invention to enhance information security.

It is a further object of the present invention to improve the speed and efficiency of big-data analytics.

It is a further object of the present invention to improve the speed and efficiency of speech recognition.

It is a further object of the present invention to enable audio search in an audio archive.

It is a further object of the present invention to improve the speed and efficiency of image recognition.

It is a further object of the present invention to enable video search in a video archive.

In accordance with these and other objects of the present invention, the present invention discloses a monolithic 3-D pattern processor supporting massive parallelism.

### SUMMARY OF THE INVENTION

The present invention discloses a monolithic 3-D pattern processor supporting massive parallelism. Its basic functionality is pattern processing. More importantly, the patterns it processes are stored locally. The preferred pattern processor comprises a plurality of storage-processing units (SPU's). Each of the SPU's comprises at least a 3-D memory (3D-M) array for storing at least a portion of a pattern and a pattern-processing circuit for performing pattern processing for the pattern. The pattern-processing circuit is disposed on a semiconductor substrate; the 3D-M array is vertically stacked above the pattern-processing circuit; and, the 3D-M array and the pattern-processing circuit are communicatively coupled by a plurality of intra-die connections.

The type of integration between the 3D-M array and the pattern-processing circuit is referred to as 3-D integration. The 3-D integration offers many advantages over the conventional 2-D integration, where the memory array and the processing circuit are placed side-by-side on the substrate of a processor die.

First of all, for the 3-D integration, the footprint of the SPU is the larger one of the 3D-M array and the pattern-processing circuit. In contrast, for the 2-D integration, the footprint of a conventional processor is the sum of the 3D-M array and the pattern-processing circuit. Hence, the SPU of the present invention is smaller. With a smaller SPU, the preferred pattern processor comprises a larger number of SPU's, typically on the order of thousands to tens of thousands. Because all SPU's can perform pattern processing simultaneously, the preferred pattern processor supports massive parallelism.

Secondly, for the 3-D integration, the 3D-M array is in close proximity to the pattern-processing circuit. Because the contact vias between the 3D-M array and the pattern-processing circuit are short (microns) and numerous (thousands), fast intra-die connections can be achieved. In comparison, for the 2-D integration, because the memory array is distant from the processing circuit, the wires coupling them are long (hundreds of microns) and few (e.g. 64-bit).

Lastly, although the peripheral circuits of the 3D-M arrays are formed on the substrate, they only occupy a small substrate area and most substrate area can be used to form the pattern-processing circuits. Because the peripheral circuits of the 3D-M arrays need to be formed anyway and the pattern-processing circuits can be manufactured at the same time, inclusion of the pattern-processing circuits adds little or no extra cost from the perspective of the 3D-M arrays.

Accordingly, the present invention discloses a monolithic three-dimensional (3-D) pattern processor supporting massive parallelism, comprising a semiconductor substrate having transistors thereon; an input for transferring at least a first portion of a first pattern; a plurality of storage-processing units (SPU's) communicatively coupled with said input, each of said SPU's comprising: at least a 3-D memory (3D-M) array for storing at least a second portion of a second pattern; a pattern-processing circuit for performing pattern processing for said first and second patterns; wherein said pattern-processing circuit is disposed on said semiconductor substrate; said 3D-M array is stacked above said pattern-processing circuit; and, said 3D-M array and said pattern-processing circuit are communicatively coupled by a plurality of intra-die connections.

### BRIEF DESCRIPTION OF THE DRAWINGS

FIG. 1A is a circuit block diagram of a preferred pattern-processor die; FIG. 1B is a circuit block diagram of a preferred storage-processing unit (SPU);

FIGS. 2A-2D are cross-sectional views of four preferred pattern processors;

FIGS. 3A-3C are circuit block diagrams of three preferred SPU's;

FIGS. 4A-4C are circuit layout views of three preferred SPU's on the substrate.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

As used hereinafter, the symbol “/” means the relationship of “and” or “or”. The phrase “memory” is used in its broadest sense to mean any semiconductor device, which can store information for short term or long term. The phrase “memory array (e.g. 3D-M array)” is used in its broadest sense to mean a collection of all memory cells sharing at least an address line. The phrase “circuits on a substrate” is used in its broadest sense to mean that all active elements (e.g. transistors, memory cells) or portions thereof are located in the substrate, even though the interconnects coupling these active elements are located above the substrate. The phrase “circuits above a substrate” is used in its broadest sense to mean that all active elements (e.g. transistors, memory cells) are located above the substrate, not in the substrate. The phrase “communicatively coupled” is used in its broadest sense to mean any coupling whereby electrical signals may be passed from one element to another element. The phrase “pattern” could refer to either pattern per se, or the data related to a pattern; the present invention does not differentiate them.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention discloses a monolithic 3-D pattern processor supporting massive parallelism. Its basic functionality is pattern processing; and, at least a portion of the patterns it processes are stored locally. The preferred pattern processor comprises a plurality of storage-processing units (SPU's). Each of the SPU's comprises at least a 3-D memory (3D-M) array for storing at least a portion of a pattern and a pattern-processing circuit for performing pattern processing for the pattern. The pattern-processing circuit is disposed on a semiconductor substrate; the 3D-M array is vertically stacked above the pattern-processing circuit. Being monolithic, the 3D-M arrays and the pattern-processing circuits of the preferred pattern processor are formed on a single die and communicatively coupled by a plurality of intra-die connections.

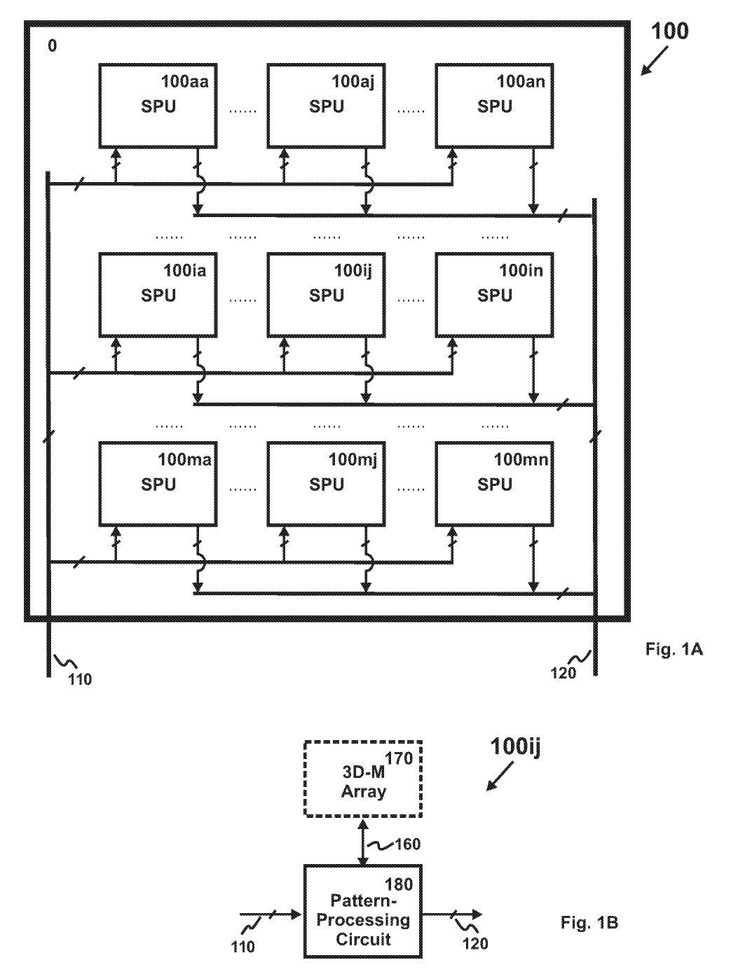

Referring now to FIGS. 1A-1B, an overview of a preferred die of the monolithic 3-D pattern processor (i.e. pattern-processor die) 100 is disclosed. FIG. 1A is its circuit block diagram. The preferred pattern-processor die 100 not only processes patterns, but also stores patterns. It comprises an array with m rows and n columns (m×n) of storage-processing units (SPU's) 100aa-100mn. Using the SPU 100ij as an example, it has an input 110 and an output 120. In general, a pattern-processor die 100 comprises thousands to tens of thousands of SPU's 100aa-100mn and therefore, supports massive parallelism.

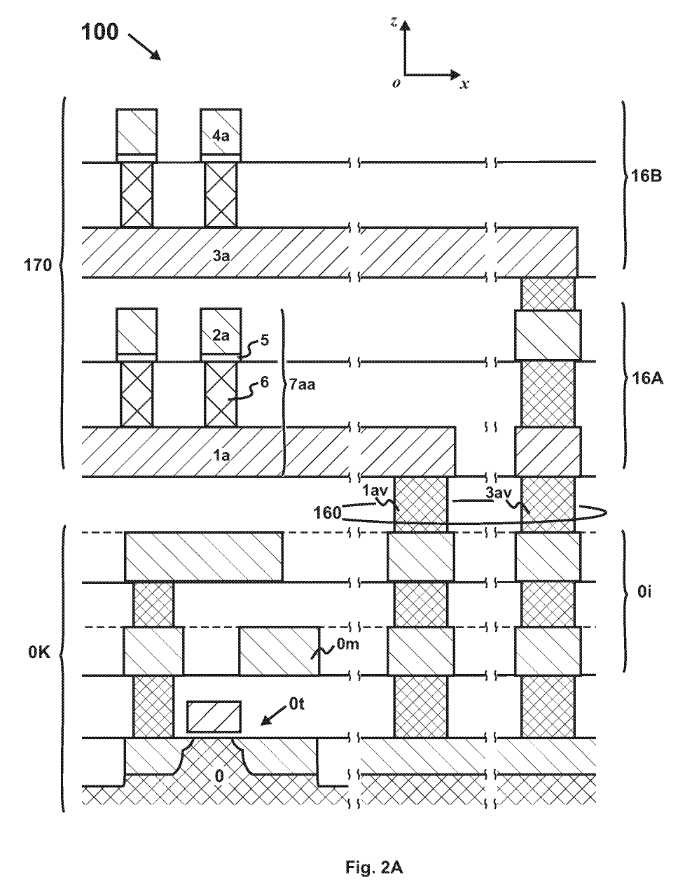

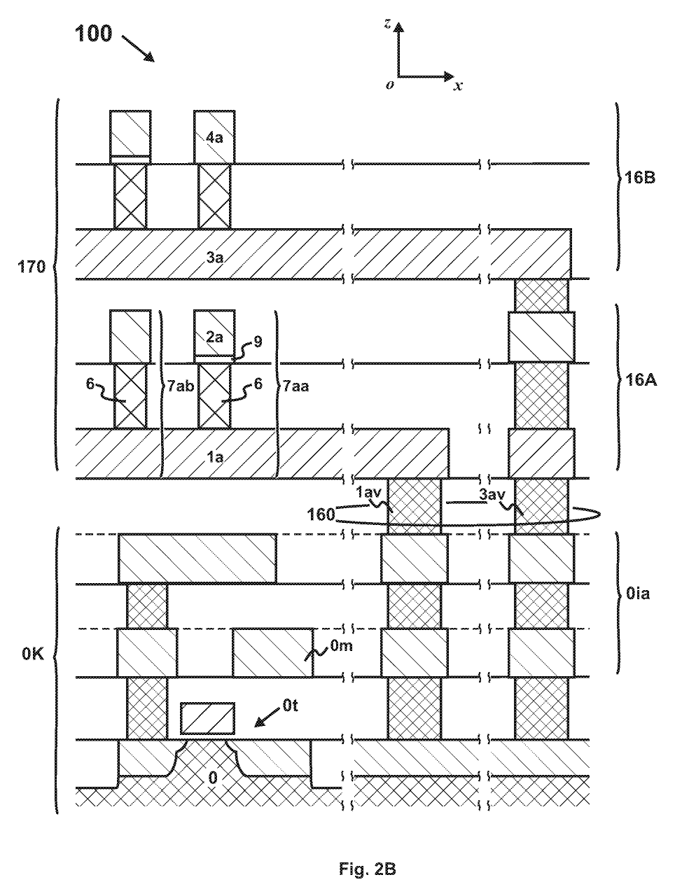

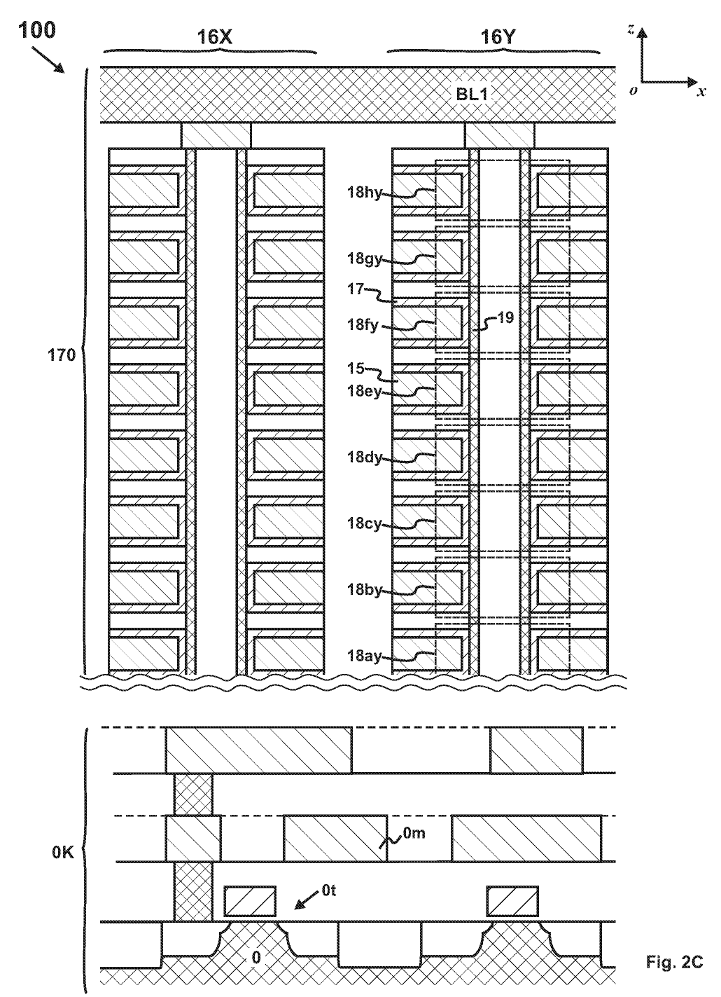

FIG. 1B is a circuit block diagram of a preferred SPU 100ij. The SPU 100ij comprises a pattern-storage circuit 170 and a pattern-processing circuit 180, which are communicatively coupled by intra-die connections 160 (referring to FIGS. 2A-2B). The pattern-storage circuit 170 comprises at least a 3D-M array. The 3D-M array 170 stores at least a portion of a pattern, whereas the pattern-processing circuit 180 processes these data. Because the 3D-M array 170 is located on a different physical plane than the pattern-processing circuit 180 (referring to FIGS. 2A-2D), the 3D-M array 170 is drawn by dashed lines.

Referring now to FIGS. 2A-2D, four preferred pattern processors 100 comprising the 3D-M arrays 170 are shown. Each of the 3D-M arrays 170 uses monolithic integration per se, i.e. the memory cells are vertically stacked without any semiconductor substrate therebetween.

Based on its physical structure, the 3D-M can be categorized into horizontal 3D-M (3D-MH) and vertical 3D-M (3D-Mv). In a 3D-M_{H}, all address lines are horizontal. The memory cells form a plurality of horizontal memory levels which are vertically stacked above each other. A well-known 3D-M_{H} is 3D-XPoint. In a 3D-Mᵥ, at least one set of the address lines are vertical. The memory cells form a plurality of vertical memory strings which are placed side-by-side on/above the substrate. A well-known 3D-Mᵥ is 3D-NAND. In general, the 3D-M_{H} (e.g. 3D-XPoint) is faster, while the 3D-Mᵥ (e.g. 3D-NAND) is denser.

Based on the data storage time, the 3D-M can be categorized into 3D-RAM (random access memory) and 3D-ROM (read-only memory). The 3D-RAM can store data for short term and can be used as cache. The 3D-ROM can store data for long term. It is a non-volatile memory (NVM). Most 3D-M arrays in the present invention are 3D-ROM.

Based on the programming methods, the 3D-M can be categorized into 3-D writable memory (3D-W) and 3-D printed memory (3D-P). The 3D-W cells are electrically programmable. Based on the number of programmings allowed, the 3D-W can be further categorized into three-dimensional one-time-programmable memory (3D-OTP) and three-dimensional multiple-time-programmable memory (3D-MTP, including re-programmable). Common 3D-MTP includes 3D-XPoint and 3D-NAND. Other 3D-MTP's include memristor, resistive random-access memory (RRAM or ReRAM), phase-change memory (PCM), programmable metallization cell (PMC) memory, conductive-bridging random-access memory (CBRAM), and the like.

For the 3D-P, data are recorded into the 3D-P cells using a printing method during manufacturing. These data are fixedly recorded and cannot be changed after manufacturing. The printing methods include photo-lithography, nano-imprint, e-beam lithography, DUV lithography, and laser-programming, etc. An exemplary 3D-P is three-dimensional mask-programmed read-only memory (3D-MPROM), whose data are recorded by photo-lithography. Because a 3D-P cell does not require electrical programming and can be biased at a larger voltage during read than the 3D-W cell, the 3D-P is faster.

In FIGS. 2A-2B, the pattern processor 100 comprises a substrate circuit OK and a plurality of 3D-M_{H} arrays 170 vertically stacked thereon. The substrate circuit OK includes transistors 0t and metal lines 0m. The transistors 0t are disposed on a semiconductor substrate 0. The metal lines 0m form substrate interconnects 0i, which communicatively couple the transistors 0t. The 3D-M_{H} array 170 includes two memory levels 16A, 16B, with the memory level 16A stacked on the substrate circuit OK and the memory level 16B stacked on the memory level 16A. Memory cells (e.g. 7aa) are disposed at the intersections between two address lines (e.g. 1a, 2a). The memory levels 16A, 16B are communicatively coupled with the substrate circuit OK through contact vias 1av, 3av, which form intra-die connections (also known as inter-storage-processor connections, or ISP connections) 160. The contact vias 1av, 3av comprise a plurality of vias, each of which is communicatively coupled with the vias above and below. Apparently, the intra-die connections 160 do not penetrate the semiconductor substrate 0 and have a size substantially smaller than that of the 3D-M_{H} arrays 170.

The 3D-M_{H} arrays 170 in FIG. 2A are 3D-W arrays. Its memory cell 7aa comprises a programmable layer 5 and a diode layer 6. The programmable layer 5 could be an antifuse layer (which can be programmed once and used for the 3D-OTP) or a resistive RAM (RRAM) layer (which can be re-programmed and used for the 3D-MTP). The diode layer 6 is broadly interpreted as any layer whose resistance at the read voltage is substantially lower than when the applied voltage has a magnitude smaller than or polarity opposite to that of the read voltage. The diode could be a semiconductor diode (e.g. p-i-n silicon diode), or a metal-oxide (e.g. TiO₂) diode. In other embodiments, the diode layer 6 is also referred to as a steering element, a selector, a selection device, or other similar names.

The 3D-MH arrays 170 in FIG. 2B are 3D-P arrays. It has at least two types of memory cells: a high-resistance memory cell 7aa, and a low-resistance memory cell 7ac. The low-resistance memory cell 7ac comprises a diode layer 6, which is similar to that in the 3D-W; whereas, the high-resistance memory cell 5aa comprises at least a high-resistance layer 9, which could simply be a layer of insulating dielectric (e.g. silicon oxide, or silicon nitride). It can be physically removed at the location of the low-resistance memory cell 7ac during manufacturing.

In FIGS. 2C-2D, the pattern processor 100 comprises a substrate circuit OK and a plurality of 3D-Mᵥ arrays 170 vertically stacked thereon. The substrate circuit OK is similar to those in FIGS. 2A-2B. The 3D-Mᵥ array 170 comprises a plurality of vertically stacked horizontal address lines 15. The 3D-Mᵥ array 170 also comprises a set of vertical address lines, which are perpendicular to the surface of the substrate 0. The 3D-Mᵥ has the largest storage density among semiconductor memories. For reason of simplicity, the intra-die connections 160 between the 3D-Mᵥ arrays 170 and the substrate circuit OK are not shown. They are similar to those in the 3D-M_{H} arrays 170 and well known to those skilled in the art.

The preferred 3D-Mᵥ array 170 in FIG. 2C is based on vertical transistors or transistor-like devices. It comprises a plurality of vertical memory strings 16X, 16Y placed side-by-side. Each memory string (e.g. 16Y) comprises a plurality of vertically stacked memory cells (e.g. 18ay-18hy). Each memory cell (e.g. 18fy) comprises a vertical transistor, which includes a gate (acts as a horizontal address line) 15, a storage layer 17, and a vertical channel (acts as a vertical address line) 19. The storage layer 17 could comprise oxide-nitride-oxide layers, oxide-poly silicon-oxide layers, or the like. This preferred 3D-Mᵥ array 170 is a 3D-NAND and its manufacturing details are well known to those skilled in the art.

The preferred 3D-Mᵥ array 170 in FIG. 2D is based on vertical diodes or diode-like devices. In this preferred embodiment, the 3D-Mᵥ array comprises a plurality of vertical memory strings 16U-16W placed side-by-side. Each memory string (e.g. 16U) comprises a plurality of vertically stacked memory cells (e.g. 18au-18hu). The 3D-Mᵥ array 170 comprises a plurality of horizontal address lines (word lines) 15 which are vertically stacked above each other. After etching through the horizontal address lines 15 to form a plurality of vertical memory wells 11, the sidewalls of the memory wells 11 are covered with a programmable layer 13. The memory wells 11 are then filled with a conductive materials to form vertical address lines (bit lines) 19. The conductive materials could comprise metallic materials or doped semiconductor materials. The memory cells 18au-18hu are formed at the intersections of the word lines 15 and the bit line 19. The programmable layer 13 could be one-time-programmable (OTP, e.g. an antifuse layer) or multiple-time-programmable (MTP, e.g. an RRAM layer).

To minimize interference between memory cells, a diode is preferably formed between the word line 15 and the bit line 19. In a first embodiment, this diode is the programmable layer 13 per se, which could have an electrical characteristic of a diode. In a second embodiment, this diode is formed by depositing an extra diode layer on the sidewall of the memory well (not shown in this figure). In a third embodiment, this diode is formed naturally between the word line 15 and the bit line 19, i.e. to form a built-in junction (e.g. P-N junction, or Schottky junction). More details on the built-in diode are disclosed in U.S. patent application Ser. No. 16/137,512, filed on Sep. 20, 2018.

In the preferred embodiments of FIGS. 2A-2D, the 3D-M array 170 is vertically stacked above the pattern-processing circuit 180. This type of integration is referred to as 3-D integration. The 3-D integration offers many advantages over the conventional 2-D integration, where the memory array and the processing circuit are placed side-by-side on the substrate of a conventional processor die.

First of all, for the 3-D integration, the footprint of the SPU 100ij is the larger one of the 3D-M array 170 and the pattern-processing circuit 180. In contrast, for the 2-D integration, the footprint of a conventional processor is the sum of the 3D-M array and the pattern-processing circuit. Hence, the SPU 100ij of the present invention is smaller. With a smaller SPU 100ij, a pattern-processor die 100 comprises a larger number of SPU's, typically on the order of thousands to tens of thousands. Because all SPU's can perform pattern processing simultaneously, the preferred pattern processor 100 supports massive parallelism.

Secondly, for the 3-D integration, the 3D-M array 170 is in close proximity to the pattern-processing circuit 180. Because the contact vias 1av, 3av between the 3D-M array 170 and the pattern-processing circuit 180 are short (microns) and numerous (thousands), fast intra-die connections 160 can be achieved. In comparison, for the 2-D integration, because the memory array is distant from the processing circuit, the wires coupling them are long (hundreds of microns) and few (e.g. 64-bit).

Lastly, although the peripheral circuits of the 3D-M arrays 170 are formed on the substrate 0, they only occupy a small substrate area and most substrate area can be used to form the pattern-processing circuits 180. Because the peripheral circuits of the 3D-M arrays 170 need to be formed anyway and the pattern-processing circuits 180 can be manufactured at the same time, inclusion of the pattern-processing circuits 180 adds little or no extra cost from the perspective of the 3D-M arrays 170.

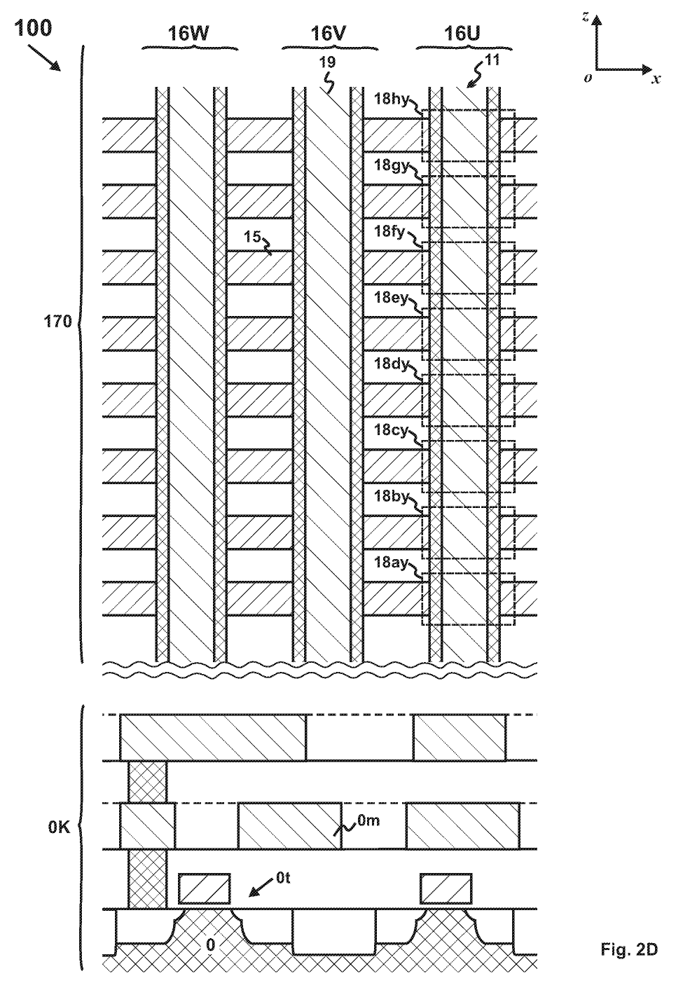

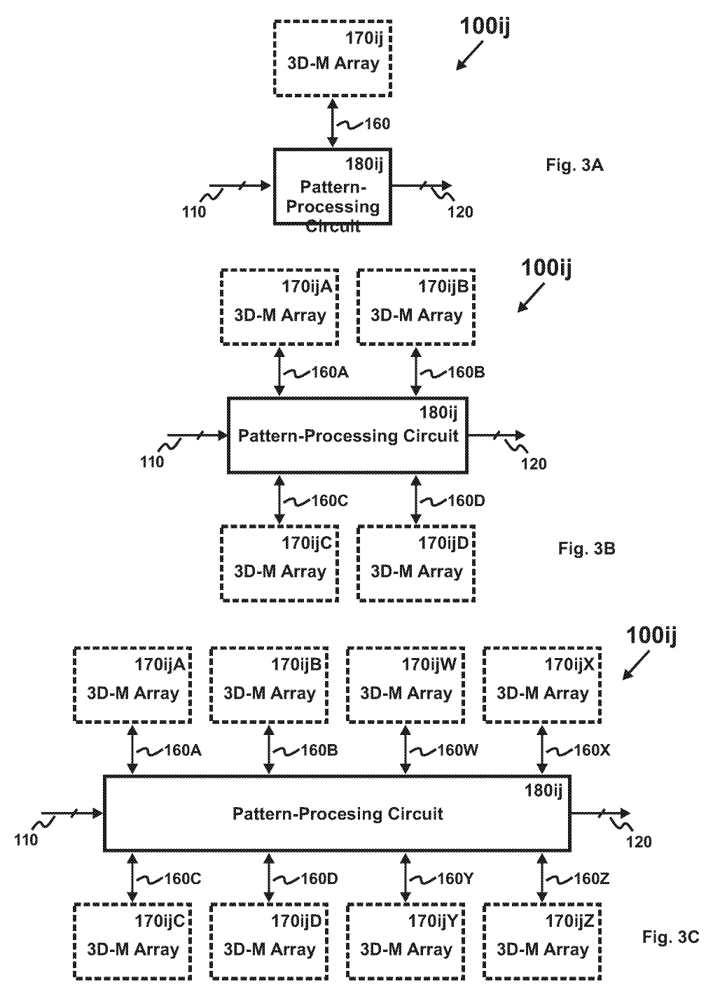

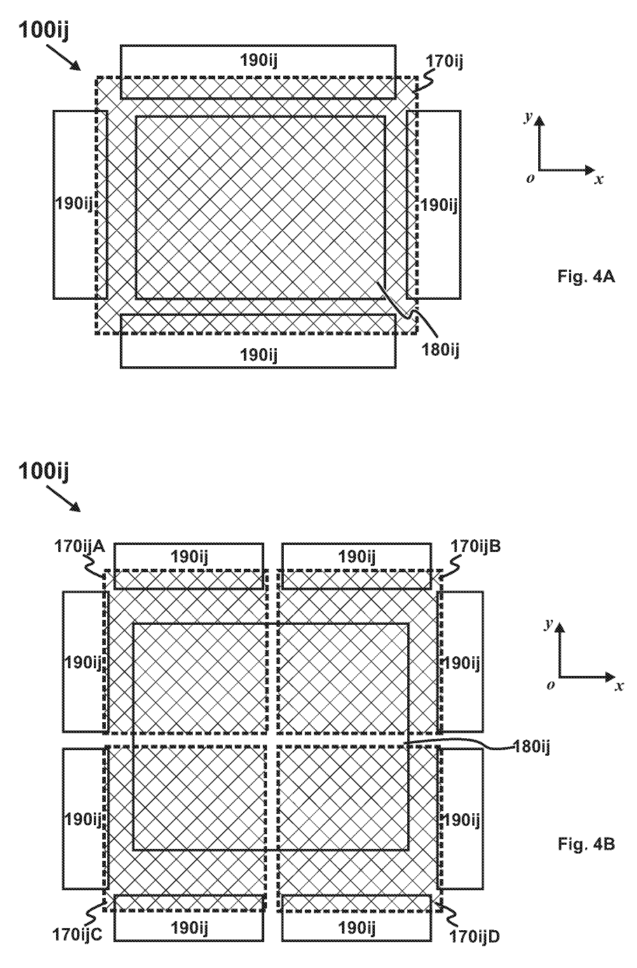

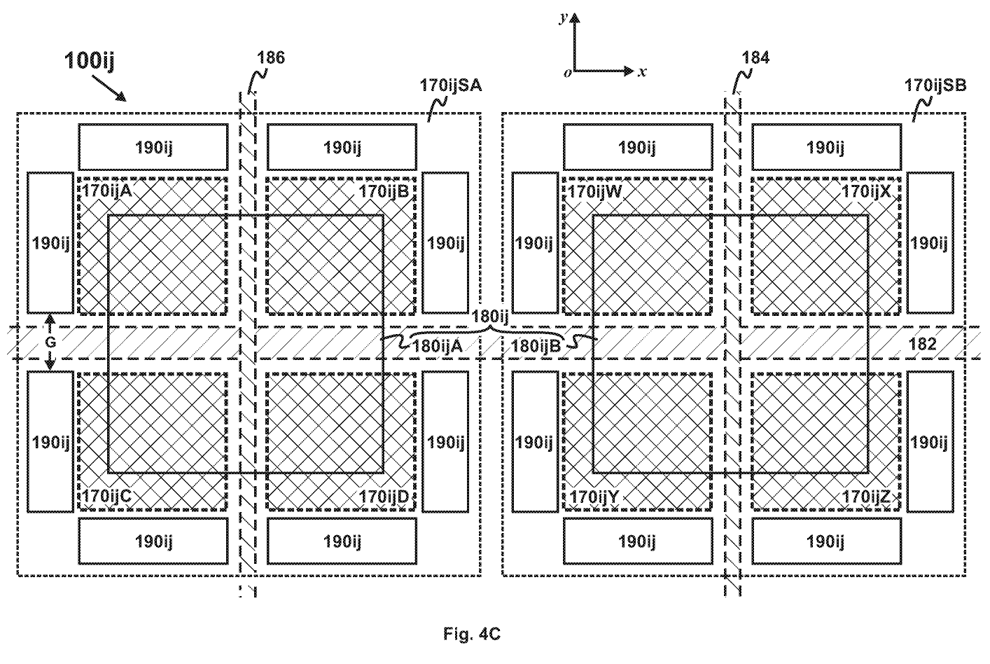

Referring now to FIGS. 3A-4C, three preferred SPU 100ij are shown. FIGS. 3A-4C are their circuit block diagrams and FIGS. 4A-4C are their circuit layout views. In these preferred embodiments, a pattern-processing circuit 180ij serves different number of 3D-M arrays. To ensure massive parallelism (i.e. to ensure that there are a large number of SPU's 100aa-100mn on a pattern-processor die 100), each SPU 100ij preferably comprises no more than eight 3D-M arrays.

In FIG. 3A, each SPU 100ij comprises a single 3D-M array 170ij and therefore, the pattern-processing circuit 180ij serves this single 3D-M array 170ij, i.e. it processes the patterns stored in the 3D-M array 170ij. In FIG. 3B, each SPU 100ij comprises four 3D-M arrays 170ijA-100ijD and therefore, the pattern-processing circuit 180ij serves four 3D-M arrays 170ijA-170ijD, i.e. it processes the patterns stored in four 3D-M arrays 170ijA-170ijD. In FIG. 3C, each SPU 100ij comprises eight 3D-M arrays 170ijA-100ijD, 170ijW-170ijZ and therefore, the pattern-processing circuit 180ij serves eight 3D-M arrays 170ijA-170ijD, 170ijW-170ijZ, i.e. it processes the patterns stored in the 3D-M arrays 170ijA-170ijD, 170ijW-170ijZ. Because they are located on a different physical plane than the pattern-processing circuit 180ij (referring to FIGS. 2A-2D), the 3D-M arrays 170ij-170ijZ are drawn by dashed lines.

FIGS. 4A-4C disclose the circuit layouts of the pattern-processing circuits 180, as well as the projections of the 3D-M arrays 170 on the substrate 0 (drawn by dashed lines). The embodiment of FIG. 4A corresponds to that of FIG. 3A. In this preferred embodiment, the pattern-processing circuit 180ij and the peripheral circuit 190ij of the 3D-M array 170ij are disposed on the substrate 0. They are at least partially covered by the 3D-M array 170ij. In this preferred embodiment, the pitch of the pattern-processing circuit 180ij is equal to the pitch of the 3D-M array 170ij. Because its area is smaller than the footprint of the 3D-M array 170ij, the pattern-processing circuit 180ij has limited functionalities. FIGS. 4B-4C discloses two complex pattern-processing circuits 180ij.

The embodiment of FIG. 4B corresponds to that of FIG. 3B. In this preferred embodiment, the pattern-processing circuit 180ij and the peripheral circuits 190ij of the 3D-M arrays 170ijA-170ijD are disposed on the substrate 0. They are at least partially covered by the 3D-M arrays 170ijA-170ijD. Below the four 3D-M arrays 170ijA-170ijD, the pattern-processing circuit 180ij can be laid out freely. Because the pitch of the pattern-processing circuit 180ij is twice as much as the pitch of the 3D-M arrays 170ijA-170ijD, the pattern-processing circuit 180ij is nearly four times larger than the footprints of the 3D-M arrays 170ijA-170ijD and therefore, can accommodate more complex functionalities.

The embodiment of FIG. 4C corresponds to that of FIG. 3C. The 3D-M arrays 170ijA-170ijD, 170ijW-170ijZ are divided into two sets: a first set 170ijSA includes four 3D-M arrays 170ijA-170ijD, and a second set 170ijSB includes four 3D-M arrays 170ijW-170ijZ. Below the four 3D-M arrays 170ijA-170ijD of the first set 170ijSA, a first component 180ijA of the pattern-processing circuit 180ij can be laid out freely. Similarly, below the four 3D-M arrays 170ijW-170ijZ of the second set 170ijSB, a second component 180ijB of the pattern-processing circuit 80ij can be laid out freely. The first and second components 180ijA, 180ijB collectively form the pattern-processing circuit 180ij. In this embodiment, adjacent peripheral circuits 190ij of the 3D-M arrays are separated by physical gaps (e.g. G) for forming the routing channel 182, 184, 186, which provide coupling between different components 180ijA, 180ijB, or between different pattern-processing circuits. Because the pitch of the pattern-processing circuit 180ij is four times as much as the pitch of the 3D-M arrays 170ijA-170ijD, 170ijW-170ijZ (along the x direction), the pattern-processing circuit 180ij is nearly eight times larger than the footprints of the 3D-M arrays 170ijA-170ijD, 170ijW-170ijZ and therefore, can accommodate even more complex functionalities.

The preferred monolithic 3-D pattern processor 100 can be either processor-like or storage-like. The processor-like 3-D pattern processor 100 acts like a monolithic 3-D processor with an embedded search-pattern library. It searches a target pattern from the input 110 against the search-pattern library. To be more specific, the 3D-M array 170 stores at least a portion of the search-pattern library (e.g. a virus library, a keyword library, an acoustic/language model library, an image model library); the input 110 includes a target pattern (e.g. a network packet, a computer file, audio data, or image data); the pattern-processing circuit 180 performs pattern processing on the target pattern with the search pattern. Because a large number of the SPU's 100ij (thousands to tens of thousands, referring to FIG. 1A) support massive parallelism and the intra-die connections 160 has a large bandwidth (referring to FIGS. 2A-2B), the preferred 3-D pattern processor with an embedded search-pattern library can achieve fast and efficient search.

Accordingly, the present invention discloses a monolithic 3-D processor with an embedded search-pattern library, comprising a semiconductor substrate having transistors thereon; an input for transferring at least a portion of a target pattern; a plurality of storage-processing units (SPU's) communicatively coupled with said input, each of said SPU's comprising: at least a 3-D memory (3D-M) array for storing at least a portion of a search pattern; a pattern-processing circuit for performing pattern processing on said target pattern with said search patterns; wherein said pattern-processing circuit is disposed on said semiconductor substrate; said 3D-M array is stacked above said pattern-processing circuit; and, said 3D-M array and said pattern-processing circuit are communicatively coupled by a plurality of intra-die connections.

The storage-like monolithic 3-D pattern processor 100 acts like a 3-D storage with in-situ pattern-processing capabilities. Its primary purpose is to store a target-pattern database, with a secondary purpose of searching the stored target-pattern database for a search pattern from the input 110. To be more specific, a target-pattern database (e.g. computer files on a whole disk drive, a big-data database, an audio archive, an image archive) is stored and distributed in the 3D-M arrays 170; the input 110 include at least a search pattern (e.g. a virus signature, a keyword, a model); the pattern-processing circuit 180 performs pattern processing on the target pattern with the search pattern. Because a large number of the SPU's 100ij (thousands to tens of thousands, referring to FIG. 1A) support massive parallelism and the intra-die connections 160 has a large bandwidth (referring to FIGS. 2A-2B), the preferred 3-D storage can achieve a fast speed and a good efficiency.

Like the flash memory, a large number of the preferred monolithic 3-D storages 100 can be packaged into a storage card (e.g. an SD card, a TF card) or a solid-state drive (i.e. SSD). These storage cards or SSD can be used to store massive data in the target-pattern database. More importantly, they have in-situ pattern-processing (e.g. searching) capabilities. Because each SPU 100ij has its own pattern-processing circuit 180, it only needs to search the data stored in the local 3D-M array 170 (i.e. in the same SPU 100ij). As a result, no matter how large is the capacity of the storage card or the SSD, the processing time for the whole storage card or the whole SSD is similar to that for a single SPU 100ij. In other words, the search time for a database is irrelevant to its size, mostly within seconds.

In comparison, for the conventional von Neumann architecture, the processor (e.g. CPU) and the storage (e.g. HDD) are physically separated. During search, data need to be read out from the storage first. Because of the limited bandwidth between the CPU and the HDD, the search time for a database is limited by the read-out time of the database. As a result, the search time for the database is proportional to its size. In general, the search time ranges from minutes to hours, even longer, depending on the size of the database. Apparently, the preferred 3-D storage with in-situ pattern-processing capabilities 100 has great advantages in database search.

When a preferred 3-D storage with in-situ pattern-processing capabilities 100 performs pattern processing for a large database (i.e. target-pattern database), the pattern-processing circuit 180 could just perform partial pattern processing. For example, the pattern-processing circuit 180 only performs a preliminary pattern processing (e.g. code matching, or string matching) on the database. After being filtered by this preliminary pattern-processing step, the remaining data from the database are sent through the output 120 to an external processor (e.g. CPU, GPU) to complete the full pattern processing. Because most data are filtered out by this preliminary pattern-processing step, the data output from the preferred 3-D storage 100 are a small fraction of the whole database. This can substantially alleviate the bandwidth requirement on the output 120.

Accordingly, the present invention discloses a monolithic 3-D storage with in-situ pattern-processing capabilities, comprising a semiconductor substrate having transistors thereon; an input for transferring at least a portion of a search pattern; a plurality of storage-processing units (SPU's) communicatively coupled with said input, each of said SPU's comprising: at least a 3-D memory (3D-M) array for storing at least a portion of a target pattern; a pattern-processing circuit for performing pattern processing on said target pattern with said search patterns; wherein said pattern-processing circuit is disposed on said semiconductor substrate; said 3D-M array is stacked above said pattern-processing circuit; and, said 3D-M array and said pattern-processing circuit are communicatively coupled by a plurality of intra-die connections.

In the following paragraphs, applications of the preferred monolithic 3-D pattern processor 100 are described. The fields of applications include: A) information security; B) big-data analytics; C) speech recognition; and D) image recognition. Examples of the applications include: a) information-security processor; b) anti-virus storage; c) data-analysis processor; d) searchable storage; e) speech-recognition processor; f) searchable audio storage; g) image-recognition processor; h) searchable image storage.

A) Information Security

Information security includes network security and computer security. To enhance network security, virus in the network packets needs to be scanned. Similarly, to enhance computer security, virus in the computer files (including computer software) needs to be scanned. Generally speaking, virus (also known as malware) includes network viruses, computer viruses, software that violates network rules, document that violates document rules and others. During virus scan, a network packet or a computer file is compared against the virus patterns (also known as virus signatures) in a virus library. Once a match is found, the portion of the network packet or the computer file which contains the virus is quarantined or removed.

Nowadays, the virus library has become large. It has reached hundreds of MB. On the other hand, the computer data that require virus scan are even larger, typically on the order of GB or TB, even bigger. On the other hand, each processor core in the conventional processor can typically check a single virus pattern once. With a limited number of cores (e.g. a CPU contains tens of cores; a GPU contains hundreds of cores), the conventional processor can achieve limited parallelism for virus scan. Furthermore, because the processor is physically separated from the storage in the von Neumann architecture, it takes a long time to fetch new virus patterns. As a result, the conventional processor and its associated architecture have a poor performance for information security.

To enhance information security, the present invention discloses several monolithic 3-D pattern processors 100. It could be processor-like or storage-like. For processor-like, the preferred monolithic 3-D pattern processor 100 is an information-security processor, i.e. a processor for enhancing information security; for storage-like, the preferred monolithic 3-D pattern processor 100 is an anti-virus storage, i.e. a storage with in-situ anti-virus capabilities.

a) Information-Security Processor

To enhance information security, the present invention discloses an information-security processor 100. It searches a network packet or a computer file for various virus patterns in a virus library. If there is a match with a virus pattern, the network packet or the computer file contains the virus. The preferred information-security processor 100 can be installed as a standalone processor in a network or a computer; or, integrated into a network processor, a computer processor, or a computer storage.

In the preferred information-security processor 100, the 3D-M arrays 170 in different SPU 100ij stores different virus patterns. In other words, the virus library is stored and distributed in the SPU's 100ij of the preferred information-security processor 100. Once a network packet or a computer file is received at the input 110, at least a portion thereof is sent to all SPU's 100ij. In each SPU 100ij, the pattern-processing circuit 180 compares said portion of data against the virus patterns stored in the local 3D-M array 170. If there is a match with a virus pattern, the network packet or the computer file contains the virus.

The above virus-scan operations are carried out by all SPU's 100ij at the same time. Because it comprises a large number of SPU's 100ij (thousands to tens of thousands), the preferred information-security processor 100 achieves massive parallelism for virus scan. Furthermore, because the intra-die connections 160 are numerous and the pattern-processing circuit 180 is physically close to the 3D-M arrays 170 (compared with the conventional von Neumann architecture), the pattern-processing circuit 180 can easily fetch new virus patterns from the local 3D-M array 170. As a result, the preferred information-security processor 100 can perform fast and efficient virus scan. In this preferred embodiment, the 3D-M arrays 170 storing the virus library could be 3D-P, 3D-OTP or 3D-MTP; and, the pattern-processing circuit 180 is a code-matching circuit.

Accordingly, the present invention discloses a monolithic information-security processor, comprising a semiconductor substrate having transistors thereon; an input for transferring at least a portion of data from a network packet or a computer file; a plurality of storage-processing units (SPU's) communicatively coupled with said input, each of said SPU's comprising: at least a 3-D memory (3D-M) array for storing at least a portion of a virus pattern; a code-matching circuit for searching said virus pattern in said portion of data; wherein said code-matching circuit is disposed on said semiconductor substrate; said 3D-M array is stacked above said code-matching circuit; and, said 3D-M array and said code-matching circuit are communicatively coupled by a plurality of intra-die connections.

b) Anti-Virus Storage

Whenever a new virus is discovered, the whole disk drive (e.g. hard-disk drive, solid-state drive) of the computer needs to be scanned against the new virus. This full-disk scan process is challenging to the conventional von Neumann architecture. Because a disk drive could store massive data, it takes a long time to even read out all data, let alone scan virus for them. For the conventional von Neumann architecture, the full-disk scan time is proportional to the capacity of the disk drive.

To shorten the full-disk scan time, the present invention discloses an anti-virus storage. Its primary function is a computer storage, with in-situ virus-scanning capabilities as its secondary function. Like the flash memory, a large number of the preferred anti-virus storage 100 can be packaged into a storage card or a solid-state drive for storing massive data and with in-situ virus-scanning capabilities.

In the preferred anti-virus storage 100, the 3D-M arrays 170 in different SPU 100ij stores different data. In other words, massive computer files are stored and distributed in the SPU's 100ij of the storage card or the solid-state drive. Once a new virus is discovered and a full-disk scan is required, the pattern of the new virus is sent as input 110 to all SPU's 100ij, where the pattern-processing circuit 180 compares the data stored in the local 3D-M array 170 against the new virus pattern.

The above virus-scan operations are carried out by all SPU's 100ij at the same time and the virus-scan time for each SPU 100ij is similar. Because of the massive parallelism, no matter how large is the capacity of the storage card or the solid-state drive, the virus-scan time for the whole storage card or the whole solid-state drive is more or less a constant, which is close to the virus-scan time for a single SPU 100ij and generally within seconds. On the other hand, the conventional full-disk scan takes minutes to hours, or even longer. In this preferred embodiment, the 3D-M arrays 170 storing massive computer data are preferably 3D-MTP; and, the pattern-processing circuit 180 is a code-matching circuit.

Accordingly, the present invention discloses a monolithic anti-virus storage, comprising a semiconductor substrate having transistors thereon; an input for transferring at least a portion of a virus pattern; a plurality of storage-processing units (SPU's) communicatively coupled with said input, each of said SPU's comprising: at least a 3-D memory (3D-M) array for storing at least a portion of data from a computer file; a code-matching circuit for searching said virus pattern in said portion of data; wherein said code-matching circuit is disposed on said semiconductor substrate; said 3D-M array is stacked above said code-matching circuit; and, said 3D-M array and said code-matching circuit are communicatively coupled by a plurality of intra-die connections.

B) Big-Data Analytics

Big data is a term for a large collection of data, with main focus on unstructured and semi-structure data. An important aspect of big-data analytics is keyword search (including string matching, e.g. regular-expression matching). At present, the keyword library becomes large, while the big-data database is even larger. For such large keyword library and big-data database, the conventional processor and its associated architecture can hardly perform fast and efficient keyword search on unstructured or semi-structured data.

To improve the speed and efficiency of big-data analytics, the present invention discloses several monolithic 3-D pattern processors 100. It could be processor-like or storage-like. For processor-like, the preferred monolithic 3-D pattern processor 100 is a data-analysis processor, i.e. a processor for performing analysis on big data; for storage-like, the preferred monolithic 3-D pattern processor 100 is a searchable storage, i.e. a storage with in-situ searching capabilities.

c) Data-analysis processor

To perform fast and efficient search on the input data, the present invention discloses a data-analysis processor 100. It searches the input data for the keywords in a keyword library. In the preferred data-analysis processor 100, the 3D-M arrays 170 in different SPU 100ij stores different keywords. In other words, the keyword library is stored and distributed in the SPU's 100ij of the preferred data-analysis processor 100. Once data are received at the input 110, at least a portion thereof is sent to all SPU's 100ij. In each SPU 100ij, the pattern-processing circuit 180 compares said portion of data against various keywords stored in the local 3D-M array 170.

The above searching operations are carried out by all SPU's 100ij at the same time. Because it comprises a large number of SPU's 100ij (thousands to tens of thousands), the preferred data-analysis processor 100 achieves massive parallelism for keyword search. Furthermore, because the intra-die connections 160 are numerous and the pattern-processing circuit 180 is physically close to the 3D-M arrays 170 (compared with the conventional von Neumann architecture), the pattern-processing circuit 180 can easily fetch keywords from the local 3D-M array 170. As a result, the preferred data-analysis processor 100 can perform fast and efficient search on unstructured data or semi-structured data.

In this preferred embodiment, the 3D-M arrays 170 storing the keyword library could be 3D-P, 3D-OTP or 3D-MTP; and, the pattern-processing circuit 180 is a string-matching circuit. The string-matching circuit could be implemented by a content-addressable memory (CAM) or a comparator including XOR circuits. Alternatively, keyword can be represented by a regular expression. In this case, the sting-matching circuit 180 can be implemented by a finite-state automata (FSA) circuit.

Accordingly, the present invention discloses a monolithic data-analysis processor, comprising a semiconductor substrate having transistors thereon; an input for transferring at least a portion of a keyword; a plurality of storage-processing units (SPU's) communicatively coupled with said input, each of said SPU's comprising: at least a 3-D memory (3D-M) array for storing at least a portion of data from a big-data database; a string-matching circuit for searching said keyword in said portion of data; wherein said string-matching circuit is disposed on said semiconductor substrate; said 3D-M array is stacked above said string-matching circuit; and, said 3D-M array and said string-matching circuit are communicatively coupled by a plurality of intra-die connections.

d) Searchable Storage

Big-data analytics often requires full-database search, i.e. to search a whole big-data database for a keyword. The full-database search is challenging to the conventional von Neumann architecture. Because the big-data database is large, with a capacity of GB to TB, or even larger, it takes a long time to even read out all data, let alone analyze them. For the conventional von Neumann architecture, the full-database search time is proportional to the database size.

To improve the speed and efficiency of full-database search, the present invention discloses a searchable storage. Its primary function is database storage, with in-situ searching capabilities as its secondary function. Like the flash memory, a large number of the preferred searchable storage 100 can be packaged into a storage card or a solid-state drive for storing a big-data database and with in-situ searching capabilities.

In the preferred searchable storage 100, the 3D-M arrays 170 in different SPU 100ij stores different portions of the big-data database. In other words, the big-data database is stored and distributed in the SPU's 100ij of the storage card or the solid-state drive. During search, a keyword is sent as input 110 to all SPU's 100ij. In each SPU 100ij, the pattern-processing circuit 180 searches the portion of the big-data database stored in the local 3D-M array 170 for the keyword.

The above searching operations are carried out by all SPU's 100ij at the same time and the keyword-search time for each SPU 100ij is similar. Because of massive parallelism, no matter how large is the capacity of the storage card or the solid-state drive, the keyword-search time for the whole storage card or the whole solid-state drive is more or less a constant, which is close to the keyword-search time for a single SPU 100ij and generally within seconds. On the other hand, the conventional full-database search takes minutes to hours, or even longer. In this preferred embodiment, the 3D-M arrays 170 storing the big-data database are preferably 3D-MTP; and, the pattern-processing circuit 100 is a string-matching circuit.

Because it has the largest storage density among all semiconductor memories, the 3D-Mᵥ is particularly suitable for storing a big-data database. Among all 3D-Mᵥ, the 3D-OTPᵥ has a long data retention time and therefore, is particularly suitable for archiving. Fast searchability is important for archiving. A searchable 3D-OTPᵥ will provide a large, inexpensive archive with fast searching capabilities.

Accordingly, the present invention discloses a monolithic searchable storage, comprising a semiconductor substrate having transistors thereon; an input for transferring at least a portion of data from a big-data database; a plurality of storage-processing units (SPU's) communicatively coupled with said input, each of said SPU's comprising: at least a 3-D memory (3D-M) array for storing at least a portion of a keyword; a string-matching circuit for searching said keyword in said portion of data; wherein said string-matching circuit is disposed on said semiconductor substrate; said 3D-M array is stacked above said string-matching circuit; and, said 3D-M array and said string-matching circuit are communicatively coupled by a plurality of intra-die connections.

C) Speech Recognition

Speech recognition enables the recognition and translation of spoken language. It is primarily implemented through pattern recognition between audio data and an acoustic model/language library, which contains a plurality of acoustic models or language models. During speech recognition, the pattern processing circuit 180 performs speech recognition to the user's audio data by finding the nearest acoustic/language model in the acoustic/language model library. Because the conventional processor (e.g. CPU, GPU) has a limited number of cores and the acoustic/language model database is stored externally, the conventional processor and the associated architecture have a poor performance in speech recognition.

e) Speech-Recognition Processor

To improve the performance of speech recognition, the present invention discloses a speech-recognition processor 100. In the preferred speech-recognition processor 100, the user's audio data is sent as input 110 to all SPU 100ij. The 3D-M arrays 170 store at least a portion of the acoustic/language model. In other words, an acoustic/language model library is stored and distributed in the SPU's 100ij. The pattern-processing circuit 180 performs speech recognition on the audio data from the input 110 with the acoustic/language models stored in the 3D-M arrays 170. In this preferred embodiment, the 3D-M arrays 170 storing the models could be 3D-P, 3D-OTP, or 3D-MTP; and, the pattern-processing circuit 180 is a speech-recognition circuit.

Accordingly, the present invention discloses a monolithic speech-recognition processor, comprising a semiconductor substrate having transistors thereon; an input for transferring at least a portion of audio data; a plurality of storage-processing units (SPU's) communicatively coupled with said input, each of said SPU's comprising: at least a 3-D memory (3D-M) array for storing at least a portion of an acoustic/language model; a speech-recognition circuit for performing speech recognition on said portion of audio data with said acoustic/language model; wherein said speech-recognition circuit is disposed on said semiconductor substrate; said 3D-M array is stacked above said speech-recognition circuit; and, said 3D-M array and said speech-recognition circuit are communicatively coupled by a plurality of intra-die connections.

f) Searchable Audio Storage

To enable audio search in an audio database (e.g. an audio archive), the present invention discloses a searchable audio storage. In the preferred searchable audio storage 100, an acoustic/language model derived from the audio data to be searched for is sent as input 110 to all SPU 100ij. The 3D-M arrays 170 store at least a portion of the user's audio database. In other words, the audio database is stored and distributed in the SPU's 100ij of the preferred searching audio storage 100. The pattern-processing circuit 180 performs speech recognition on the audio data stored in the 3D-M arrays 170 with the acoustic/language model from the input 110. In this preferred embodiment, the 3D-M arrays 170 storing the audio database are preferably 3D-MTP; and, the pattern-processing circuit 180 is a speech-recognition circuit.

Accordingly, the present invention discloses a monolithic searchable audio storage, comprising a semiconductor substrate having transistors thereon; an input for transferring at least a portion of an acoustic/language model; a plurality of storage-processing units (SPU's) communicatively coupled with said input, each of said SPU's comprising: at least a 3-D memory (3D-M) array for storing at least a portion of audio data; a speech-recognition circuit for performing speech recognition on said portion of audio data with said acoustic/language model; wherein said speech-recognition circuit is disposed on said semiconductor substrate; said 3D-M array is stacked above said speech-recognition circuit; and, said 3D-M array and said speech-recognition circuit are communicatively coupled by a plurality of intra-die connections.

D) Image Recognition or Search

Image recognition enables the recognition of images. It is primarily implemented through pattern recognition on image data with an image model, which is a part of an image model library. During image recognition, the pattern processing circuit 180 performs image recognition to the user's image data by finding the nearest image model in the image model library. Because the conventional processor (e.g. CPU, GPU) has a limited number of cores and the image model database is stored externally, the conventional processor and the associated architecture have a poor performance in image recognition.

g) Image-Recognition Processor

To improve the performance of image recognition, the present invention discloses an image-recognition processor 100. In the preferred image-recognition processor 100, the user's image data is sent as input 110 to all SPU 100ij. The 3D-M arrays 170 store at least a portion of the image model. In other words, an image model library is stored and distributed in the SPU's 100ij. The pattern-processing circuit 180 performs image recognition on the image data from the input 110 with the image models stored in the 3D-M arrays 170. In this preferred embodiment, the 3D-M arrays 170 storing the models could be 3D-P, 3D-OTP, or 3D-MTP; and, the pattern-processing circuit 180 is an image-recognition circuit.

Accordingly, the present invention discloses a monolithic image-recognition processor, comprising a semiconductor substrate having transistors thereon; an input for transferring at least a portion of image data; a plurality of storage-processing units (SPU's) communicatively coupled with said input, each of said SPU's comprising: at least a 3-D memory (3D-M) array for storing at least a portion of an image model; an image-recognition circuit for performing image recognition on said portion of image data with said image model; wherein said image-recognition circuit is disposed on said semiconductor substrate; said 3D-M array is stacked above said image-recognition circuit; and, said 3D-M array and said image-recognition circuit are communicatively coupled by a plurality of intra-die connections.

h) Searchable Image Storage

To enable image search in an image database (e.g. an image archive), the present invention discloses a searchable image storage. In the preferred searchable image storage 100, an image model derived from the image data to be searched for is sent as input 110 to all SPU 100ij. The 3D-M arrays 170 store at least a portion of the user's image database. In other words, the image database is stored and distributed in the SPU's 100ij of the preferred searchable image storage 100. The pattern-processing circuit 180 performs image recognition on the image data stored in the 3D-M arrays 170 with the image model from the input 110. In this preferred embodiment, the 3D-M arrays 170 storing the image database are preferably 3D-MTP; and, the pattern-processing circuit 180 is an image-recognition circuit.

Accordingly, the present invention discloses a monolithic searchable image storage, comprising a semiconductor substrate having transistors thereon; an input for transferring at least a portion of an image model; a plurality of storage-processing units (SPU's) communicatively coupled with said input, each of said SPU's comprising: at least a 3-D memory (3D-M) array for storing at least a portion of image data; an image-recognition circuit for performing image recognition on said portion of image data with said image model; wherein said image-recognition circuit is disposed on said semiconductor substrate; said 3D-M array is stacked above said image-recognition circuit; and, said 3D-M array and said image-recognition circuit are communicatively coupled by a plurality of intra-die connections.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A monolithic three-dimensional (3-D) pattern processor supporting massive parallelism, comprising a semiconductor substrate having transistors thereon; an input for transferring at least a first portion of a first pattern; a plurality of storage-processing units (SPU's) communicatively coupled with said input, each of said SPU's comprising:
at least a 3-D memory (3D-M) array for storing at least a second portion of a second pattern;
a pattern-processing circuit for performing pattern processing for said first and second patterns;
wherein said pattern-processing circuit is disposed on said semiconductor substrate;
said 3D-M array is stacked above said pattern-processing circuit; and, said 3D-M array and said pattern-processing circuit are communicatively coupled by a plurality of intra-die connections.

2. The pattern processor according to claim 1, wherein each of said SPU's comprises no more than eight 3D-M arrays.

3. The pattern processor according to claim 2, wherein each of said SPU's comprises one 3D-M array.

4. The pattern processor according to claim 2, wherein each of said SPU's comprises four 3D-M arrays.

5. The pattern processor according to claim 1, wherein said intra-die connections include contact vias.

6. The pattern processor according to claim 5, wherein said contact vias do not penetrate said semiconductor substrate.

7. The pattern processor according to claim 5, wherein the size of said contact vias is substantially smaller than the size of said 3D-M array.

8. The pattern processor according to claim 1, wherein said 3D-M array at least partially covers said pattern-processing circuit.

9. The pattern processor according to claim 1, wherein said 3D-M is a three-dimensional horizontal memory (3D-MH).

10. The pattern processor according to claim 1, wherein said 3D-M is a three-dimensional vertical memory (3D-Mv).

11. The pattern processor according to claim 1 being a monolithic 3-D processor with embedded search-pattern library, wherein said first pattern includes a target pattern; and, said second pattern includes a search pattern.

12. The pattern processor according to claim 1 being a monolithic information-security processor, wherein said input transfers at least a portion of data from a network packet or a computer file; said 3D-M array stores at least a portion of a virus pattern; and, said pattern-processing circuit is a code-matching circuit for searching said virus pattern in said portion of data.

13. The pattern processor according to claim 1 being a monolithic data-analysis processor, wherein said input transfers at least a portion of data from a big-data database; said 3D-M array stores at least a portion of a keyword; and, said pattern-processing circuit is a string-matching circuit for searching said keyword in said portion of data.

14. The pattern processor according to claim 1 being a monolithic speech-recognition processor, wherein said input transfers at least a portion of audio data; said 3D-M array stores at least a portion of an acoustic/language model; and, said pattern-processing circuit is a speech-recognition circuit for performing speech recognition on said portion of audio data with said acoustic/language model.

15. The pattern processor according to claim 1 being a monolithic image-recognition processor, wherein said input transfers at least a portion of image data; said 3D-M array stores at least a portion of an image model; and, said pattern-processing circuit is an image-recognition circuit for performing image recognition on said portion of image data with said image model.

16. The pattern processor according to claim 1 being a monolithic 3-D storage with in-situ pattern-processing capabilities, wherein said first pattern includes a search pattern; and, said second pattern includes a target pattern.

17. The pattern processor according to claim 1 being a monolithic anti-virus storage, wherein said input transfers at least a portion of a virus pattern; said 3D-M array stores at least a portion of data from a computer file; and, said pattern-processing circuit is a code-matching circuit for searching said virus pattern in said portion of data.

18. The pattern processor according to claim 1 being a monolithic searchable storage, wherein said input transfers at least a portion of a keyword; said 3D-M array stores at least a portion of data from a big-data database; and, said pattern-processing circuit is a string-matching circuit for searching said keyword in said portion of data.

19. The pattern processor according to claim 1 being a monolithic searchable audio storage, wherein said input transfers at least a portion of an acoustic/language model; said 3D-M array stores at least a portion of audio data; and, said pattern-processing circuit is a speech-recognition circuit for performing speech recognition on said portion of audio data with said acoustic/language model.

20. The pattern processor according to claim 1 being a monolithic searchable image storage, wherein said input transfers at least a portion of an image model; said 3D-M array stores at least a portion of image data; and, said pattern-processing circuit is an image-recognition circuit for performing image recognition on said portion of image data with said image model.
